(19) United States
(12) Patent Application Publication
(10) Pub. No.: US 2026/0162581 A1
(43) Pub. Date: Jun. 11, 2026

(54) ELECTRONIC DEVICE AND DRIVING METHODS OF ELECTRONIC DEVICE

(71) Applicants: Samsung Display Co., LTD., Yongin-si (KR); UNIST(ULSAN NATIONAL INSTITUTE OF SCIENCE AND TECHNOLOGY), Ulsan (KR)

(72) Inventors: HYOSUN KIM, Yongin-si (KR); Youngshin KWAK, Ulju-gun (KR); Seonyoung YOON, Ulju-gun (KR); YOUNG-JUN SEO, Yongin-si (KR)

(21) Appl. No.: 19/182,170

(22) Filed: Apr. 17, 2025

(30) Foreign Application Priority Data
Aug. 20, 2024 (KR) 10-2024-0111037

(51) Int. Cl. G09G 3/20; G09G 3/32; G09G 3/3225

(52) U.S. Cl. CPC G09G 3/2007; G09G 3/2096; G09G 3/32; G09G 3/3225; G09G 2320/0242; G09G 2320/0666; G09G 2330/021; G09G 2340/06; G09G 2354/00; G09G 2360/141; G09G 2360/144

(57) ABSTRACT

An electronic device includes a sensor module that detects external light, a display layer that displays an image, and a signal control circuit that receives an image signal and generates image data. The signal control circuit includes a brightness ratio calculation unit that calculates a brightness ratio based on first luminance of the external light and second luminance of the image signal, a white calculation unit that converts chromaticity of the image signal into color coordinates, and a color coordinate calculation unit that calculates white color coordinates based on the brightness ratio and the color coordinates. The signal control circuit generates the image data based on the image signal and the white color coordinates.

This application claims priority to Korean Patent Application No. 10-2024-0111037, filed on Aug. 20, 2024, and all the benefits accruing therefrom under 35 U.S.C. § 119, the content of which in its entirety is herein incorporated by reference.

### BACKGROUND

### 1. Field

Embodiments of the disclosure described herein relate to an electronic device having improved display quality and a method for driving the electronic device.

### 2. Description of the Related Art

Various display devices that are used in a multi-media device such as a television, a mobile phone, a tablet computer, a navigation system, or a game console are being developed.

As fields in which these display devices are used are diversified, the types of display layers for displaying images displayed on display devices are also diversified.

Nowadays, a display layer includes a light emitting display layer. The light emitting display layer may include an organic light emitting display layer or a quantum dot light emitting display layer.

### SUMMARY

Embodiments of the disclosure provide an electronic device having improved display quality and a method for driving the electronic device.

In an embodiment of the disclosure, an electronic device includes a sensor module that detects external light, a display layer that displays an image, and includes a plurality of pixels respectively connected to a plurality of data lines and the plurality of scan lines, a data driving circuit that drives the plurality of data lines, a scan driving circuit that drives the plurality of scan lines, and a signal control circuit that generates image data and controls the data driving circuit and the scan driving circuit. The signal control circuit includes a brightness ratio calculation unit that calculates a brightness ratio based on first luminance of the external light and second luminance of the image signal, a white calculation unit that converts chromaticity of the image signal into color coordinates, and a color coordinate calculation unit that calculates white color coordinates based on the brightness ratio and the color coordinates. The signal control circuit generates the image data based on the image signal and the white color coordinates.

In an embodiment, when a ratio value obtained by dividing the first luminance by the second luminance is less than 1, the brightness ratio may have the ratio value. When the ratio value is greater than or equal to 1, the brightness ratio may have 1.

In an embodiment, the sensor module may include an illuminance sensor.

In an embodiment, the sensor module may measure an external illuminance value. The brightness ratio calculation unit may receive the external illuminance value and may calculate the first luminance by Equation 0.

$$Ambient luminance = \frac{Illuminance}{\text{?}} \times \frac{1}{5} \qquad [ Equation 0 ]$$

$$\text{?} \text{indicates text missing or illegible when filed}$$

In an embodiment, in the Equation 0, the ambient luminance denotes the first luminance, and the Illuminance denotes the external illuminance value.

In an embodiment, the color coordinate calculation unit may output a function obtained by raising the brightness ratio to power of 0.3.

In an embodiment, the image signal may include u′v′ color coordinates.

In an embodiment, the white calculation unit may include a first conversion unit that converts the u′v′ color coordinates into XYZ tristimulus values, and a second conversion unit that converts the XYZ tristimulus values into long, medium, and short (“LMS”) cone values.

In an embodiment, the color coordinate calculation unit may calculate corrected LMS cone values having a corrected color temperature based on the function and the LMS cone values.

In an embodiment, the color coordinate calculation unit may convert the corrected LMS cone values into corrected XYZ tristimulus values.

In an embodiment, the color coordinate calculation unit may normalize and output the corrected XYZ tristimulus values.

In an embodiment of the disclosure, a method of driving an electronic device includes providing the electronic device including a sensor module that detects external light, a display layer, and a signal control circuit that receives an image signal and transmits image data to the display layer, calculating, by the signal control circuit, a brightness ratio based on first luminance of the external light and second luminance of the image signal, converting, by the signal control circuit, chromaticity of the image signal into color coordinates, calculating, by the signal control circuit, white color coordinates based on the brightness ratio and the color coordinates, and generating, by the signal control circuit, the image data based on the image signal and the white color coordinates.

In an embodiment, the calculating the brightness ratio may include defining the brightness ratio as the ratio value when a ratio value obtained by dividing the first luminance by the second luminance is less than 1.

In an embodiment, the calculating the brightness ratio may further include defining the brightness ratio as 1 when the ratio value is greater than or equal to 1.

In an embodiment, the sensor module may include an illuminance sensor.

In an embodiment, the sensor module may measure an external illuminance value. The calculating the brightness ratio may include calculating, by the signal control circuit, the first luminance based on the external illuminance value.

In an embodiment, the calculating the white color coordinates may include outputting a function obtained by raising the brightness ratio to power of 0.3.

In an embodiment, the image signal may include u′v′ color coordinates. The calculating the white color coordinates may further include converting the u′v′ color coordinates into XYZ tristimulus values, and converting the XYZ tristimulus values into LMS cone values.

In an embodiment, the calculating the white color coordinates may further include calculating corrected LMS cone values having a corrected color temperature based on the function and the LMS cone values.

In an embodiment, the calculating the white color coordinates may further include converting the corrected LMS cone values into corrected XYZ tristimulus values.

In an embodiment, the calculating the white color coordinates may further include normalizing the corrected XYZ tristimulus values.

### BRIEF DESCRIPTION OF THE DRAWINGS

The above and other embodiments, advantages and features of the disclosure will become apparent by describing in detail embodiments thereof with reference to the accompanying drawings.

FIGS. 1 to 3 are perspective views of an embodiment of an electronic device, according to the disclosure.

FIG. 4 is a cross-sectional view of an embodiment of an electronic device, according to the disclosure.

FIG. 5 is a cross-sectional view of an embodiment of an electronic device taken along I-I′ of FIG. 1, according to the disclosure.

FIG. 6 is a block diagram of an embodiment of an electronic device, according to the disclosure.

FIG. 7 is a block diagram of an embodiment of a display layer and a display driver, according to the disclosure.

FIGS. 8A and 8B are graphs illustrating an embodiment of color correlated temperature (“CCT”) neutral points according to ratio values, according to the disclosure.

FIG. 9 is a flowchart illustrating an embodiment of a method of driving an electronic device, according to the disclosure.

FIG. 10 is a block diagram illustrating an embodiment of a signal control circuit, according to the disclosure.

FIG. 11 is a block diagram of an embodiment of a white calculation unit, according to the disclosure.

FIG. 12 is a block diagram of an embodiment of a color coordinate calculation unit, according to the disclosure.

FIG. 13 is a block diagram of an embodiment of a display layer and a display driver, according to the disclosure.

### DETAILED DESCRIPTION

In the specification, the expression that a first component (or region, layer, part, portion, etc.) is “on”, “connected with”, or “coupled with” a second component means that the first component is directly on, connected with, or coupled with the second component or means that a third component is interposed therebetween.

The same reference numerals refer to the same components. Also, in drawings, the thickness, ratio, and dimension of components are exaggerated for effectiveness of description of technical contents. The term “and/or” includes one or more combinations in each of which associated elements are defined.

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The articles “a,” “an,” and “the” are singular in that they have a single referent, but the use of the singular form in the specification should not preclude the presence of more than one referent.

Also, the terms “under”, “below”, “on”, “above”, etc. are used to describe the correlation of components illustrated in drawings. The terms that are relative in concept are described based on a direction shown in drawings.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Terms such as “module” and “unit” mean a software component or a hardware component that performs a specific function. For example, the hardware component may include a field-programmable gate array (“FPGA”) or an application-specific integrated circuit (“ASIC”). The software component may refer to executable codes and/or data used by the executable codes in an addressable storage medium. Accordingly, the software components may be, for example, object-oriented software components, class components, and task components, and may include processes, functions, attributes, procedures, subroutines, program code segments, drivers, firmware, microcodes, circuits, data, databases, data structures, tables, arrays, or variables.

Unless otherwise defined, all terms (including technical terms and scientific terms) used in the specification have the same meaning as commonly understood by one skilled in the art to which the disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the disclosure will be described with reference to accompanying drawings.

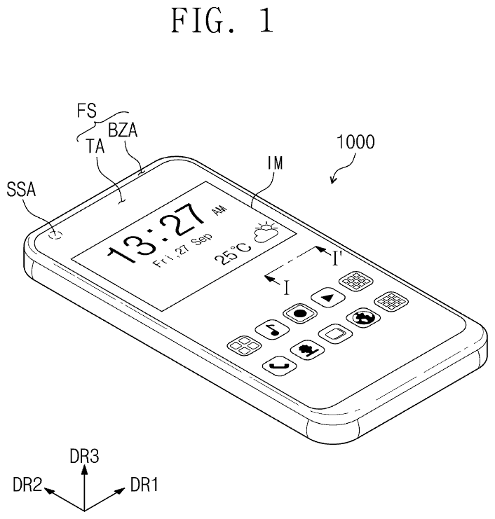

FIGS. 1 to 3 are perspective views of an embodiment of an electronic device, according to the disclosure.

Referring to FIGS. 1 to 3, an electronic device 1000 may be a device activated depending on an electrical signal. The electronic device 1000 may include various embodiments. In an embodiment, the electronic device 1000 may be used for relatively small and medium display devices such as a personal computer, a notebook computer, a personal digital terminal, an automotive navigation unit, a game console, a portable electronic device, and a camera, as well as a relatively large display device such as a television, a monitor, or an outer billboard, for example. Furthermore, these are just presented as only an embodiment. It is obvious that these are capable of being employed in other display devices as long as these do not depart from the concept of the disclosure.

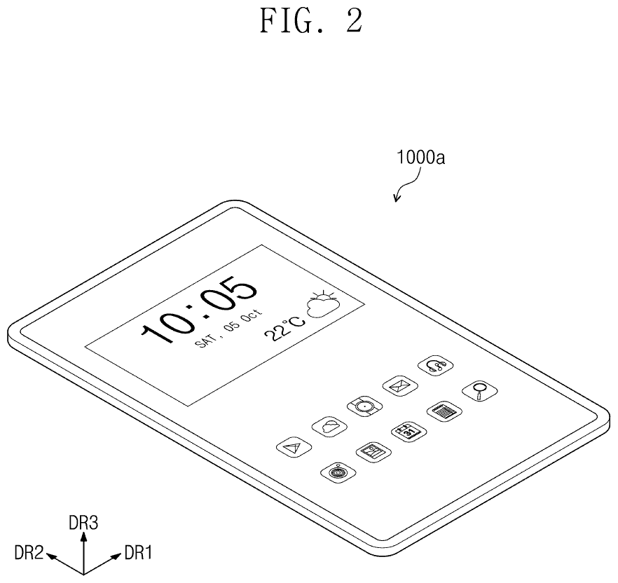

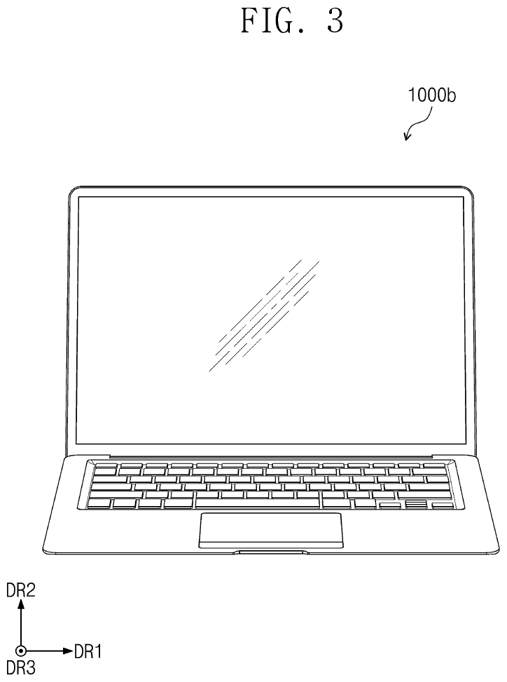

FIG. 1 illustrates the electronic device 1000 as a smart phone. FIG. 2 illustrates an electronic device 1000a is a tablet personal computer (“PC”). FIG. 3 illustrates an electronic device 1000b as a laptop.

An image IM may be displayed on a display surface FS, which is parallel to each of a first direction DR1 and a second direction DR2 of the electronic device 1000 in a third direction DR3. The display surface FS on which the image IM is displayed may correspond to a front surface of the electronic device 1000. The image IM may include a still image as well as a moving image. In FIG. 1, a clock window and application icons are illustrated in an embodiment of the image IM.

The display surface FS may be divided into a transmission area TA and a bezel area BZA. The transmission area TA may be an optically transmission area. Light transmittance of the bezel area BZA may be relatively low in comparison to the transmission area TA. The bezel area BZA may define a shape of the transmission area TA. The bezel area BZA is next (adjacent) to the transmission area TA and surrounds the transmission area TA.

The bezel area BZA may have a given color. The bezel area BZA may cover a peripheral area of the electronic device 1000 to prevent the peripheral area from being visible from the outside. However, the disclosure is not limited thereto. In an embodiment, the electronic device 1000 in an embodiment of the disclosure may not include the bezel area BZA, for example.

In an embodiment, a front surface (or a top surface) and a rear surface (or a bottom surface) of each member are defined with respect to a direction in which the image IM is displayed. The front surface and the rear surface may be opposite to each other in the third direction DR3, and a normal direction of each of the front surface and the rear surface may be parallel to the third direction DR3. The third direction DR3 may be a direction intersecting the first direction DR1 and the second direction DR2. The first direction DR1, the second direction DR2, and the third direction DR3 may be perpendicular to one another.

In the specification, a surface defined by the first direction DR1 and the second direction DR2 may be defined as a plane. “Being viewed from above a plane” may be defined as being viewed in the third direction DR3.

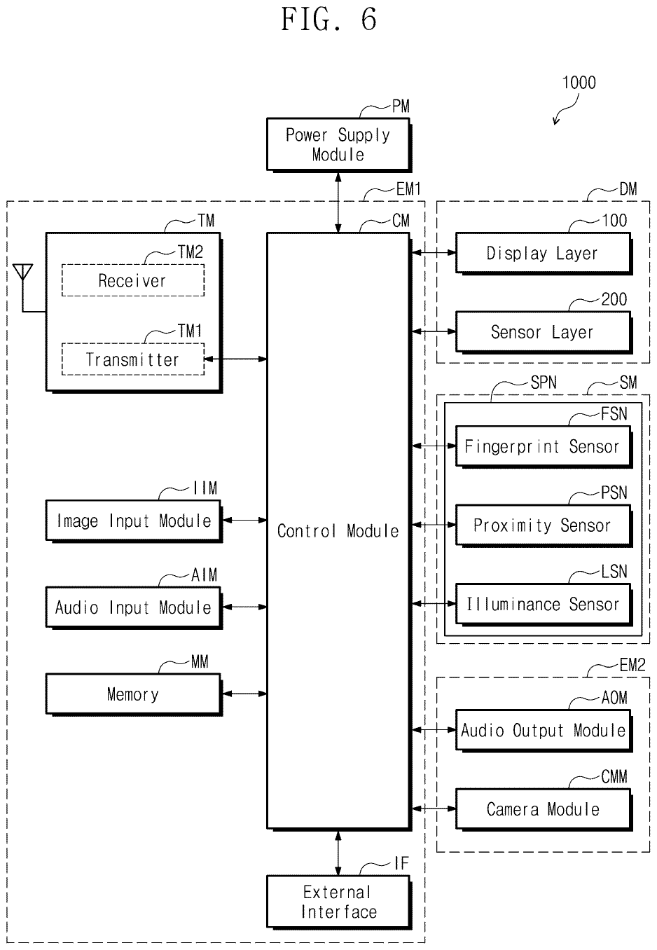

In an embodiment of the disclosure, a sensing area SSA may overlap a sensor module SM (refer to FIG. 6). The electronic device 1000 may receive an external signal desired for the sensor module SM (refer to FIG. 6) through the sensing area SSA, or may provide a signal output from the sensor module SM (refer to FIG. 6) to the outside.

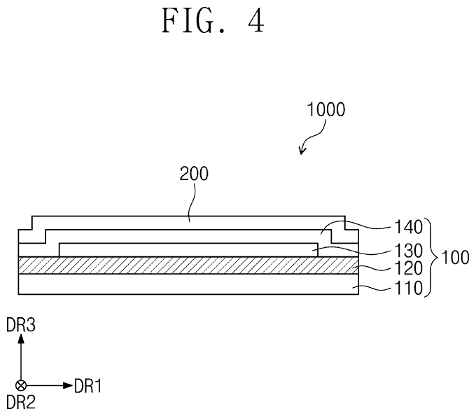

FIG. 4 is a cross-sectional view of an embodiment of an electronic device, according to the disclosure.

Referring to FIG. 4, the electronic device 1000 may include a display layer 100 and a sensor layer 200.

The display layer 100 may be a component that substantially generates the image IM (refer to FIG. 1). The display layer 100 may be a light emitting display layer. In an embodiment, the display layer 100 may be an organic light emitting display layer, a quantum dot display layer, a micro-light-emitting diode (“LED”) display layer, or a nano-LED display layer, for example. The display layer 100 may include a base layer 110, a circuit layer 120, a light emitting element layer 130, and an encapsulation layer 140.

The base layer 110 may be a member that provides a base surface on which the circuit layer 120 is disposed. The base layer 110 may be a glass substrate, a metal substrate, or a polymer substrate. However, the disclosure is not limited thereto. In an embodiment, the base layer 110 may be an inorganic layer, an organic layer, or a composite material layer, for example.

The base layer 110 may have a multi-layer structure. In an embodiment, the base layer 110 may include a first synthetic resin layer, a silicon oxide (SiOx) layer disposed on the first synthetic resin layer, an amorphous silicon (a-Si) layer disposed on the silicon oxide layer, and a second synthetic resin layer disposed on the amorphous silicon layer, for example. The silicon oxide layer and the amorphous silicon layer may be also referred to as a “base barrier layer”.

Each of the first and second synthetic resin layers may include polyimide-based resin. Also, each of the first and second synthetic resin layers may include at least one of acrylate-based resin, methacrylate-based resin, polyisoprene-based resin, vinyl-based resin, epoxy-based resin, urethane-based resin, cellulose-based resin, siloxane-based resin, polyamide-based resin, and perylene-based resin. In the meantime, “chemical component”-based resin in the specification means including the functional group of “chemical component”.

The circuit layer 120 may be disposed on the base layer 110. The circuit layer 120 may include an insulating layer, a semiconductor pattern, a conductive pattern, and a signal line. The insulating layer, the semiconductor layer, and the conductive layer may be formed on the base layer 110 in a manner such as coating, evaporation, or the like. Afterward, the insulating layer, the semiconductor layer, and the conductive layer may be selectively patterned by performing a photolithography process multiple times. Afterward, the semiconductor pattern, the conductive pattern, and the signal line included in the circuit layer 120 may be formed.

The light emitting element layer 130 may be disposed on the circuit layer 120. The light emitting element layer 130 may include a light emitting element. In an embodiment, the light emitting element layer 130 may include an organic luminescent material, a quantum dot, a quantum rod, a micro-LED, or a nano-LED, for example.

The encapsulation layer 140 may be disposed on the light emitting element layer 130. The encapsulation layer 140 may protect the light emitting element layer 130 from foreign substances such as moisture, oxygen, and dust particles.

The sensor layer 200 may be disposed on the display layer 100. The sensor layer 200 may sense an external input applied from the outside.

The sensor layer 200 may be formed on the display layer 100 through a successive process. In this case, the sensor layer 200 may be expressed as being directly disposed on the display layer 100. “Being directly disposed” may mean that the third component is not interposed between the sensor layer 200 and the display layer 100. That is, a separate adhesive member may not be interposed between the sensor layer 200 and the display layer 100. In an alternative embodiment, the sensor layer 200 may be coupled to the display layer 100 through an adhesive member. The adhesive member may include a typical adhesive or a typical sticking agent.

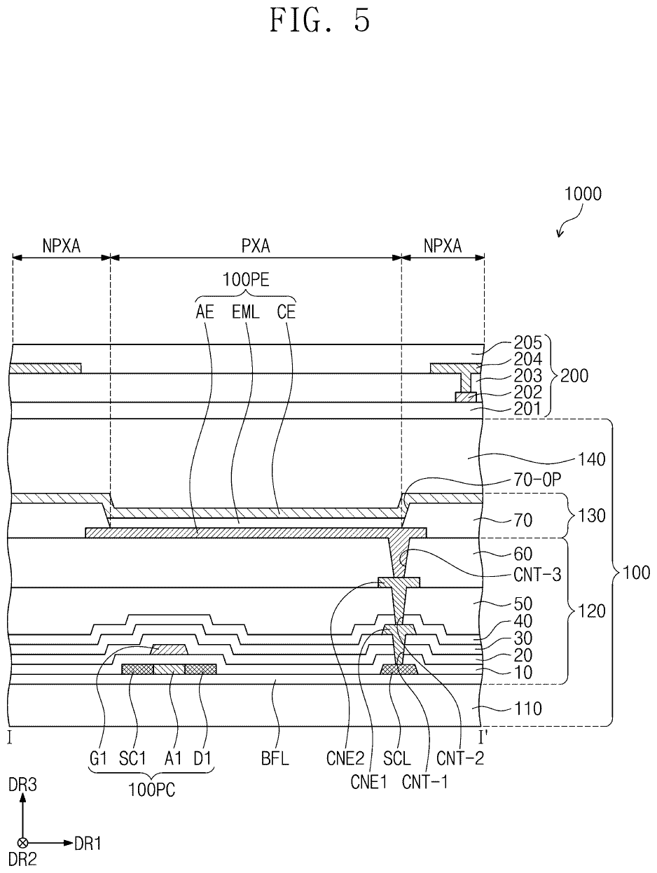

FIG. 5 is a cross-sectional view of an embodiment of an electronic device taken along I-I′ of FIG. 1, according to the disclosure. In the description of FIG. 5, the same reference numerals are assigned to the same components described with reference to FIG. 4, and thus the descriptions thereof are omitted.

Referring to FIG. 5, at least one inorganic layer may be formed on the upper surface of the base layer 110. The inorganic layer may include at least one of aluminum oxide, titanium oxide, silicon oxide, silicon oxynitride, zirconium oxide, and hafnium oxide. The inorganic layer may include or consist of multiple layers. The inorganic layers composed of multiple layers may constitute a barrier layer and/or a buffer layer. In an embodiment, the display layer 100 is illustrated as including a buffer layer BFL.

The buffer layer BFL may improve a bonding force between the base layer 110 and a semiconductor pattern. The buffer layer BFL may include a silicon oxide layer and a silicon nitride layer. The silicon oxide layer and the silicon nitride layer may be stacked alternately.

The semiconductor pattern may be disposed on the buffer layer BFL. The semiconductor pattern may include polysilicon. However, the disclosure is not limited thereto, and the semiconductor pattern may include amorphous silicon, low-temperature polycrystalline silicon, or an oxide semiconductor.

FIG. 5 only illustrates a part of the semiconductor pattern, and the semiconductor pattern may be further disposed in another area. The semiconductor pattern may be arranged in a predetermined rule throughout pixels. The semiconductor pattern may have electrical characteristics different depending on whether the semiconductor pattern is doped. The semiconductor pattern may include a first area having relatively high conductivity and a second area having relatively low conductivity. The first area may be doped with an N-type dopant or a P-type dopant. The P-type transistor may include the doped area doped with a P-type dopant, and the N-type transistor may include the doped area doped with an N-type dopant. The second area may be an undoped area or may be doped with a lower concentration than the first area.

The conductivity of the first area is greater than that of the second area. The first area may substantially operate as an electrode or a signal line. The second area may substantially correspond to an active (or a channel) of a transistor. In other words, a part of the semiconductor pattern may be an active of the transistor. Another part thereof may be a source or drain of the transistor. Another part may be a connection electrode or a connection signal line.

Each of the pixels may have an equivalent circuit including seven transistors, one capacitor, and a light emitting element. The equivalent circuit of a pixel may be modified in various shapes. The pixels will be described later. The one transistor 100PC and one light emitting element 100PE included in a pixel are illustrated in FIG. 5 as one of the embodiments.

The transistor 100PC may include a source SC1, an active A1, a drain D1, and a gate G1. The source SC1, the active A1, and the drain D1 may be formed from the semiconductor pattern. The source SC1 and the drain D1 may extend in directions opposite to each other from the active A1 in a cross-section. A part of a connection signal line SCL formed from the semiconductor pattern is illustrated in FIG. 5. Although not illustrated separately, the connection signal line SCL may be electrically connected to the drain D1 of the transistor 100PC in a plan view.

A first insulating layer 10 may be disposed on the buffer layer BFL. The first insulating layer 10 may overlap a plurality of pixels in common and may cover the semiconductor pattern. The first insulating layer 10 may be an inorganic layer and/or an organic layer, and may have a single-layer structure or a multi-layer structure. The first insulating layer 10 may include at least one of aluminum oxide, titanium oxide, silicon oxide, silicon nitride, silicon oxynitride, zirconium oxide, and hafnium oxide. In an embodiment, the first insulating layer 10 may be a single silicon oxide layer. Not only the first insulating layer 10 but also an insulating layer of the circuit layer 120 to be described later may be an inorganic layer and/or an organic layer, and may have a single-layer structure or a multi-layer structure. The inorganic layer may include at least one of the above-described materials, but is not limited thereto.

The gate G1 is disposed on the first insulating layer 10. The gate G1 may be a part of a metal pattern. The gate G1 overlaps the active A1. In a process of doping the semiconductor pattern, the gate G1 may function as a mask.

A second insulating layer 20 is disposed on the first insulating layer 10 and may cover the gate G1. The second insulating layer 20 may overlap pixels in common. The second insulating layer 20 may be an inorganic layer and/or an organic layer, and may have a single-layer structure or a multi-layer structure. The second insulating layer 20 may include at least one of silicon oxide, silicon nitride, and silicon oxynitride. In an embodiment, the second insulating layer 20 may have a multi-layer structure including a silicon oxide layer and a silicon nitride layer.

A third insulating layer 30 may be disposed on the second insulating layer 20. The third insulating layer 30 may have a single-layer structure or a multi-layer structure. In an embodiment, the third insulating layer 30 may have a multi-layer structure including a silicon oxide layer and a silicon nitride layer, for example.

A first connection electrode CNE1 may be disposed on the third insulating layer 30. The first connection electrode CNE1 may be connected to the connection signal line SCL through a contact hole CNT-1 penetrating the first, second, and third insulating layers 10, 20, and 30.

A fourth insulating layer 40 may be disposed on the third insulating layer 30. The fourth insulating layer 40 may be a single silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 penetrating the fourth insulating layer 40 and the fifth insulating layer 50.

A sixth insulating layer 60 may be disposed on the fifth insulating layer 50 and may cover the second connection electrode CNE2. The sixth insulating layer 60 may be an organic layer.

The light emitting element layer 130 may be disposed on the circuit layer 120. The light emitting element layer 130 may include the light emitting element 100PE. In an embodiment, the light emitting element layer 130 may include an organic luminescent material, a quantum dot, a quantum rod, a micro-LED, or a nano-LED, for example. Hereinafter, the description will be given under the condition that the light emitting element 100PE is an organic light emitting element, but an embodiment is not particularly limited thereto.

The light emitting element 100PE may include a first electrode AE, a light emitting layer EML, and a second electrode CE. The first electrode AE may be disposed on the sixth insulating layer 60. The first electrode AE may be connected to the second connection electrode CNE2 through a contact hole CNT-3 penetrating the sixth insulating layer 60.

A pixel defining film 70 may be disposed on the sixth insulating layer 60 and may cover a portion of the first electrode AE. An opening 70-OP is defined in the pixel defining film 70. The opening 70-OP of the pixel defining film 70 exposes at least part of the first electrode AE.

The display surface FS (refer to FIG. 1) may include an emission area PXA and a non-emission area NPXA next (adjacent) to the emission area PXA. The non-emission area NPXA may surround the emission area PXA. In an embodiment, the emission area PXA is defined to correspond to a partial area of the first electrode AE, which is exposed by the opening 70-OP.

The light emitting layer EML may be disposed on the first electrode AE. The light emitting layer EML may be disposed in an area corresponding to the opening 70-OP. That is, the light emitting layer EML may be separately formed on each of pixels. When the light emitting layers EML are separately formed in each of pixels, each of the light emitting layers EML may emit light of at least one of a blue color, a red color, and a green color. However, the disclosure is not limited thereto. In an embodiment, the light emitting layer EML may be connected and provided to each of the pixels in common, for example. In this case, the light emitting layer EML may provide blue light or white light.

The second electrode CE may be disposed on the light emitting layer EML. The second electrode CE may be disposed in a plurality of pixels in common while having an integral shape. The second electrode CE may be also referred to as a common electrode CE.

Although not illustrated, a hole control layer may be interposed between the first electrode AE and the light emitting layer EML. The hole control layer may be disposed in common in the emission area PXA and the non-emission area NPXA. The hole control layer may include a hole transport layer and may further include a hole injection layer. An electron control layer may be interposed between the light emitting layer EML and the second electrode CE. The electron control layer may include an electron transport layer and may further include an electron injection layer. The hole control layer and the electron control layer may be formed in common in a plurality of pixels by an open mask.

The encapsulation layer 140 may be disposed on the light emitting element layer 130. The encapsulation layer 140 may include an inorganic layer, an organic layer, and an inorganic layer sequentially stacked, and layers constituting the encapsulation layer 140 are not limited thereto.

The inorganic layers may protect the light emitting element layer 130 from moisture and oxygen, and the organic layer may protect the light emitting element layer 130 from a foreign material such as dust particles. The inorganic layers may include a silicon nitride layer, a silicon oxynitride layer, a silicon oxide layer, a titanium oxide layer, an aluminum oxide layer, or the like. The organic layer may include an acrylate-based organic layer, but is not limited thereto.

The sensor layer 200 may be formed on the display layer 100 through a successive process. In this case, the sensor layer 200 may be expressed as being directly disposed on the display layer 100. “Being directly disposed” may mean that the third component is not interposed between the sensor layer 200 and the display layer 100. That is, a separate adhesive member may not be interposed between the sensor layer 200 and the display layer 100. In an alternative embodiment, the sensor layer 200 may be coupled to the display layer 100 through an adhesive member. The adhesive member may include a typical adhesive or a typical sticking agent.

The sensor layer 200 may include a base insulating layer 201, a first conductive layer 202, a sensing insulating layer 203, a second conductive layer 204, and a cover insulating layer 205.

The base insulating layer 201 may be an inorganic layer including at least one of silicon nitride, silicon oxynitride, and silicon oxide. In an alternative embodiment, the base insulating layer 201 may be an organic layer including an epoxy resin, an acrylate resin, or an imide-based resin. The base insulating layer 201 may have a single-layer structure or may have a multi-layer structure stacked in the third direction DR3.

Each of the first conductive layer 202 and the second conductive layer 204 may have a single-layer structure or may have a multi-layer structure in which layers are stacked in the third direction DR3.

A conductive layer of a single-layer structure may include a metal layer or a transparent conductive layer. The metal layer may include molybdenum, silver, titanium, copper, aluminum, or any alloys thereof. The transparent conductive layer may include a transparent conductive oxide such as indium tin oxide (“ITO”), indium zinc oxide (“IZO”), zinc oxide (ZnO), indium zinc tin oxide (“IZTO”), or the like. Besides, the transparent conductive layer may include a conductive polymer such as poly(3,4-ethylenedioxythiophene) (“PEDOT”), a metal nano wire, graphene, or the like.

A conductive layer of the multi-layer structure may include metal layers. In an embodiment, the metal layers may have a three-layer structure of titanium/aluminum/titanium, for example. The conductive layer of the multi-layer structure may include at least one metal layer and at least one transparent conductive layer.

At least one of the sensing insulating layer 203 and the cover insulating layer 205 may include an inorganic film. The inorganic film may include at least one of aluminum oxide, titanium oxide, silicon oxide, silicon nitride, silicon oxynitride, zirconium oxide, and hafnium oxide.

At least one of the sensing insulating layer 203 and the cover insulating layer 205 may include an organic film. The organic film may include at least one of acrylate-based resin, methacrylate-based resin, polyisoprene, vinyl-based resin, epoxy-based resin, urethane-based resin, cellulose-based resin, siloxane-based resin, polyimide-based resin, polyamide-based resin, and perylene-based resin.

FIG. 6 is a block diagram of an embodiment of an electronic device, according to the disclosure.

Referring to FIG. 6, the electronic device 1000 may include a display module DM, a power supply module PM, a first electronic module EM1, a second electronic module EM2, and the sensor module SM. The display module DM, the power supply module PM, the first electronic module EM1, the second electronic module EM2, and the sensor module SM may be electrically connected to each other.

The power supply module PM may supply power desired for overall operations of the electronic device 1000. The power supply module PM may include a general battery module.

Each of the first electronic module EM1 and the second electronic module EM2 may include various functional modules for operating the electronic device 1000. The first electronic module EM1 may be directly disposed (e.g., mounted) on a main board electrically connected to the display module DM or may be disposed (e.g., mounted) on a separate board so as to be electrically connected to the main board through a connector (not illustrated).

The first electronic module EM 1 may include a control module CM, a wireless communication module TM, an image input module IM, an audio input module AIM, a memory MM, and an external interface IF. Some of the modules may be electrically connected to the main board through a flexible circuit board without being disposed (e.g., mounted) on the main board.

The control module CM may control overall operations of the electronic device 1000. The control module CM may activate or deactivate the display module DM. The control module CM may control other modules such as the image input module IM, the audio input module AIM, or the like based on a touch signal received from the display module DM. The control module CM may control an operation of the electronic device 1000 in response to a signal detected by the sensor module SM.

The wireless communication module TM may transmit/receive wireless signals with another terminal by Bluetooth® or Wi-Fi. The wireless communication module TM may transmit/receive voice signals by general communication lines. The wireless communication module TM may include a transmitter TM1, which modulates and transmits a transmission signal, and a receiver TM2 that demodulates a reception signal.

The image input module UM may convert an image signal into image data to be displayed on the display module DM by processing the image signal. The audio input module AIM may receive an external sound signal from a microphone in a recording mode or a speech recognition mode and then may convert the external sound signal into electrical voice data.

The external interface IF may operate as an interface that connects to an external charger, a wired/wireless data port, a card socket (e.g., a memory card, a subscriber identity module/user identity module (“SIM/UIM”) card, or the like), or the like.

The second electronic module EM2 may include an audio output module AOM, and a camera module CMM. The audio output module AOM and the camera module CMM may be disposed (e.g., mounted) directly on a main board, may be disposed (e.g., mounted) on a separate board so as to be electrically connected to the display module DM through a connector (not illustrated), or may be electrically connected to the first electronic module EM1.

The audio output module AOM may convert audio data received from the wireless communication module TM or audio data stored in the memory MM and then may output the converted data to the outside. The camera module CMM may capture an external image.

The sensor module SM may include a sensor panel SPN. The sensor panel SPN may include a fingerprint sensor FSN, a proximity sensor PSN, and an illuminance sensor LSN. The fingerprint sensor FSN, the proximity sensor PSN, and the illuminance sensor LSN may be placed in the single sensor panel SPN. However, this is an illustrative embodiment. The placement relationship of the fingerprint sensor FSN, the proximity sensor PSN, and the illuminance sensor LSN in the disclosure is not limited thereto.

The fingerprint sensor FSN may detect a fingerprint provided on the display module DM. The control module CM may receive fingerprint information detected by the fingerprint sensor FSN and may implement a user authentication mode by the received fingerprint information.

The proximity sensor PSN may detect an object around the electronic device 1000. The control module CM may control an operation of the display module DM based on information detected by the proximity sensor PSN. In an embodiment, when the electronic device 1000 is a mobile phone and a user makes a call while holding the mobile phone to his/her ear, the control module CM may turn off a screen of the electronic device 1000 to reduce power consumption of the electronic device 1000, for example.

The illuminance sensor LSN may detect light outside the electronic device 1000. The control module CM may control the operation of the display module DM based on information detected by the illuminance sensor LSN. The illuminance sensor LSN may be placed to overlap the sensing area SSA (refer to FIG. 1).

When the ambient luminance is high, the control module CM may increase the luminance of light generated by the display module DM. When the ambient luminance is low, the control module CM may decrease the luminance of the light generated by the display module DM.

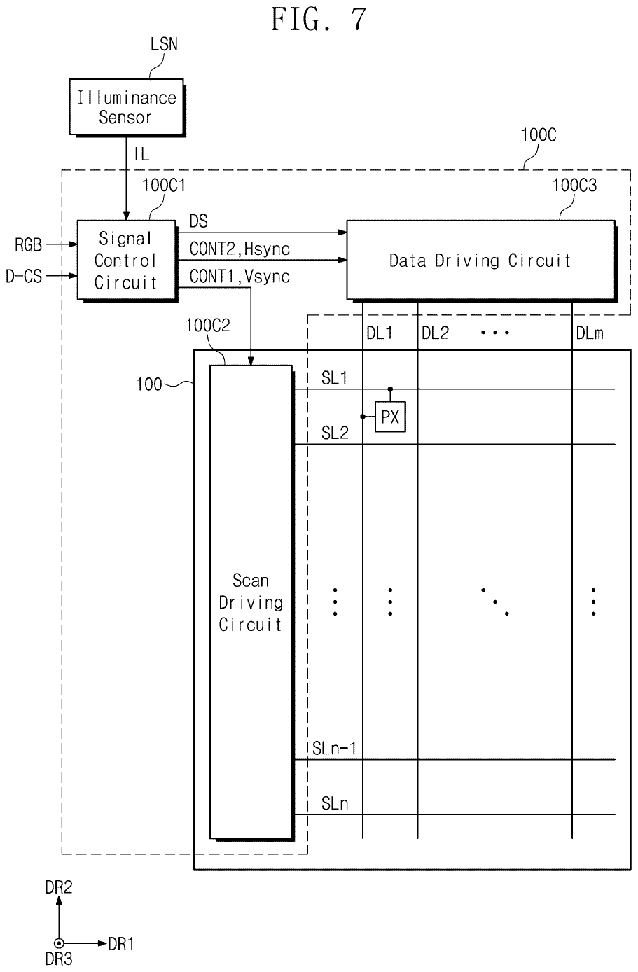

Moreover, the control module CM may generate an image signal RGB (refer to FIG. 7) for controlling the output of the display layer 100, by adjusting a neutral point of the display layer 100. The neutral point may be defined as the color emitted by the display layer 100 when neutral color such as white is displayed.

The user's visual system may chromatically adapt to ambient light (e.g., light emitted by the electronic device 1000, light emitted by other light sources such as the sun or a light bulb, or the like) near the user.

In determining what lighting the user is adapted to, the control module CM may determine an adapted neutral point based on an adaptation factor indicating how heavily the light emitted by the electronic device 1000 needs to be weighted against the ambient light from other light sources.

The display module DM may include the display layer 100 and the sensor layer 200. The display layer 100 may display an image by an image signal provided from the control module CM.

The sensor layer 200 may sense an external input (the user's hand, a touch pen, or the like). The sensed signal may be transmitted to the control module CM as an input signal. The control module CM may control an operation of the display layer 100 in response to the input signal.

FIG. 7 is a block diagram of an embodiment of a display layer and a display driver, according to the disclosure.

Referring to FIG. 7, the display layer 100 may include a plurality of scan wires SL1 to SLn (n is a natural number), a plurality of data wires DL1 to DLm (m is a natural number), and a plurality of pixels PX. Each of the plurality of pixels PX is connected to the corresponding data wire among the plurality of data wires DL1 to DLm and is connected to the corresponding scan wire among the plurality of scan wires SL1 to SLn. In an embodiment of the disclosure, the display layer 100 may further include light emitting control wires, and a display driver 100C may further include an emission driving circuit that provides control signals to light emitting control wires. The configuration of the display layer 100 is not particularly limited thereto.

Each of the plurality of scan wires SL1 to SLn may extend in the first direction DR1. The plurality of scan wires SL1 to SLn may be arranged spaced apart from one another in the second direction DR2. The plurality of data wires DL1 to DLm may extend in the second direction DR2. The plurality of data wires DL1 to DLm may be arranged spaced apart from one another in the first direction DR1.

The display driver 100C may include a signal control circuit 100C1, a scan driving circuit 100C2, and a data driving circuit 100C3.

The signal control circuit 100C1 may receive the image signal RGB and a control signal D-CS from the control module CM (refer to FIG. 6). The control signal D-CS may include various signals. In an embodiment, the control signal D-CS may include an input vertical synchronization signal, an input horizontal synchronization signal, a main clock, and a data enable signal, for example.

The illuminance sensor LSN may measure an external illuminance value IL. The illuminance value IL may be calculated from the external light detected by the illuminance sensor LSN. The signal control circuit 100C1 may receive the illuminance value IL from the illuminance sensor LSN.

On the basis of the control signal D-CS, the signal control circuit 100C1 may generate a first control signal CONT1 and a vertical synchronization signal Vsync, and may output the first control signal CONT1 and the vertical synchronization signal Vsync to the scan driving circuit 100C2.

On the basis of the control signal D-CS, the signal control circuit 100C1 may generate a second control signal CONT2 and a horizontal synchronization signal Hsync, and may output the second control signal CONT2 and the horizontal synchronization signal Hsync to the data driving circuit 100C3.

Furthermore, the signal control circuit 100C1 may output, to the data driving circuit 100C3, image data DS obtained by processing the image signal RGB to be suitable for an operating condition of the display layer 100. The first control signal CONT1 and the second control signal CONT2 are signals desired for operations of the scan driving circuit 100C2 and the data driving circuit 100C3 and are not particularly limited thereto.

The scan driving circuit 100C2 drives the plurality of scan wires SL1 to SLn in response to the first control signal CONT1 and the vertical synchronization signal Vsync. In an embodiment of the disclosure, the scan driving circuit 100C2 may be formed in the same process as the circuit layer 120 (refer to FIG. 4) in the display layer 100, but is not limited thereto. In an embodiment, the scan driving circuit 100C2 may be implemented as an integrated circuit (“IC”), for example. The scan driving circuit 100C2 may be directly disposed (e.g., mounted) in a predetermined area of the display layer 100 or may be disposed (e.g., mounted) on a separate printed circuit board in a chip on film (“COF”) scheme, and then may be electrically connected to the display layer 100.

The data driving circuit 100C3 may output grayscale voltages to the plurality of data wires DL1 to DLm in response to the second control signal CONT2, the horizontal synchronization signal Hsync, and the image data DS that are received from the signal control circuit 100C1. The data driving circuit 100C3 may be implemented with IC. The data driving circuit 100C3 may be directly disposed (e.g., mounted) in a predetermined area of the display layer 100 or may be disposed (e.g., mounted) on a separate printed circuit board in a COF scheme, and then may be electrically connected to the display layer 100, but is not particularly limited thereto. In an embodiment, the data driving circuit 100C3 may be formed in the same process as the circuit layer 120 (refer to FIG. 4) in the display layer 100, for example.

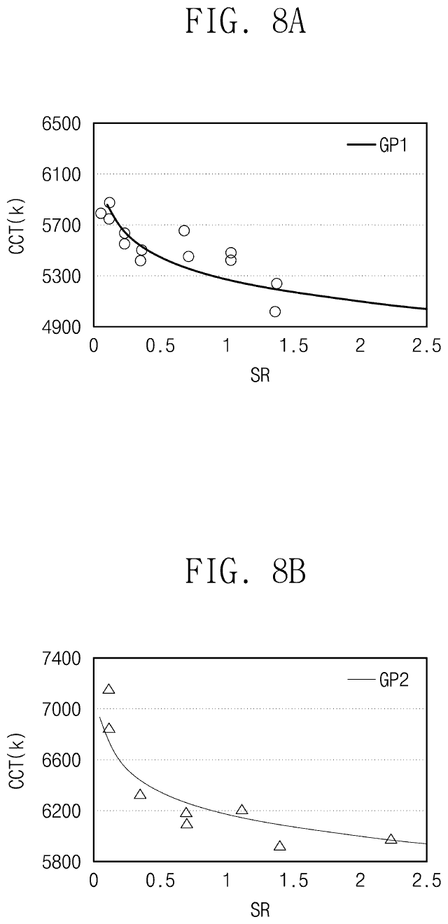

FIGS. 8A and 8B are graphs illustrating an embodiment of color correlated temperature (“CCT”) neutral points according to ratio values, according to the disclosure.

Referring to FIGS. 7, 8A, and 8B, a horizontal axis of each of graphs GP1 and GP2 may be defined as a ratio value SR. The ratio value SR may be defined as a value obtained by dividing first luminance of external light by second luminance of the image signal RGB. That is, the ratio value SR may be defined by Equation 1.

$$\text{?} = {Y}_{W} / Y \qquad [ Equation 1 ]$$

$$\text{?} \text{indicates text missing or illegible when filed}$$

In Equation 1, S̅_̅{̅R̅}̅ may denote the ratio value SR; Y̅_̅{̅W̅}̅ may denote first luminance; and Y̅ may denote second luminance.

A vertical axis may be defined as a CCT neutral point. The CCT is a scale indicating the color of light. As the color temperature of light is higher, color appears to be bluer. As the color temperature of light is lower, color appears to be redder. The CCT neutral point may refer to a point indicating neutral white in the color temperature scale. In general, the point is a temperature at which a white light source reproduces color close to color in actual natural light. The unit of CCT neutral point may be Kelvin (K).

The first graph GP1 has been measured when the external light had a color temperature of 3000 K. A plurality of circle values on a coordinate plane on the first graph GP1 is obtained as the color temperature perceived by a user as the neutral point is collected when external lighting has a color temperature of 3000 K, and the color temperature is organized depending on the ratio value SR. That is, the plurality of circle values may be experimental values.

The second graph GP2 was measured when the external light had a color temperature of 5000 K. A plurality of triangle values on a coordinate plane on the second graph GP2 is obtained as the color temperature perceived by a user as the neutral point is collected when external lighting has a color temperature of 5000 K, and the color temperature is organized depending on the ratio value SR. That is, the plurality of triangle values may be experimental values.

Referring to the plurality of circle values and the plurality of triangle values, abrupt changes in the CCT neutral point may occur within a range of the ratio value SR from 0 to 0.5.

When the ratio value SR exceeds 1.0, the CCT neutral point may gradually converge to a predetermined level. In an embodiment, the CCT neutral point converges to 5000 K in external light of 3000 K, and converges to 5900 K in external light of 5000 K, for example.

That is, even when the color temperature of the external lighting is the same, the neutral white color of the display surface FS (refer to FIG. 1) perceived by the user may vary depending on the ratio value SR of the luminance of each of the external light and the display layer 100.

The first graph GP1 and the second graph GP2, which are derived based on the experimental values, may satisfy Equation 2.

$$\text{?} = \text{?} + ( 1 - ln ( \text{?} ) ) , ( 0.05 < \text{?} < \text{?} ) , when \qquad [ Equation 2 ]$$

$$\text{?} is lower than 7 , 800 \text{?}$$

$$\text{?} \text{indicates text missing or illegible when filed}$$

In Equation 2, C̅C̅T̅_̅{̅N̅e̅u̅t̅r̅a̅l̅ p̅o̅i̅n̅t̅}̅ may denote a CCT neutral point; C̅C̅T̅_̅{̅A̅d̅a̅p̅t̅e̅d̅ w̅h̅i̅t̅e̅}̅ may denote the predetermined level that converges depending on the color temperature of external light; and may denote the ratio value SR.

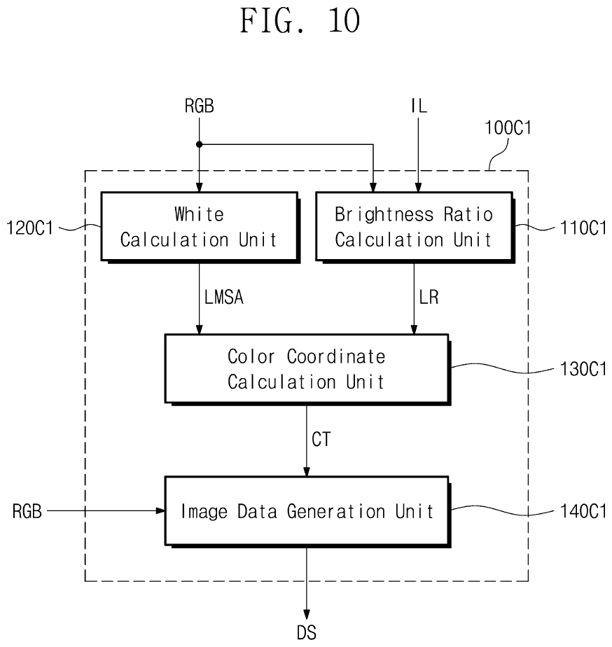

Referring to Equation 2, the CCT neutral point may be determined by the ratio value SR. Setting the neutral point of the electronic device 1000 may play an important role in improving display quality because it affects color including richness, hue, naturalness, and preference. In an embodiment of the disclosure, the signal control circuit 100C1 may generate the image data DS based on the image signal RGB, and a white color coordinates CT (refer to FIG. 10) calculated based on the ratio value SR. Accordingly, the electronic device 1000 with improved display quality may be provided.

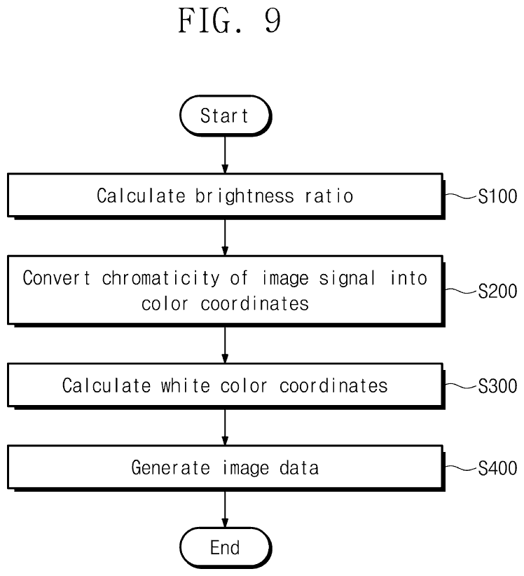

FIG. 9 is a flowchart illustrating an embodiment of a method of driving an electronic device, according to the disclosure. FIG. 10 is a block diagram illustrating an embodiment of a signal control circuit, according to the disclosure.

Referring to FIGS. 7, 9, and 10, the driving method of the electronic device 1000 in an embodiment of the disclosure may include operation S100 of calculating, by the signal control circuit 100C1, a brightness ratio LR based on first luminance of external light and second luminance of the image signal RGB, operation S200 of converting, by the signal control circuit 100C1, chromaticity of the image signal RGB into a color coordinates LMSA, operation S300 of calculating, by the signal control circuit 100C1, the white color coordinates CT based on the brightness ratio LR and the color coordinates LMSA, and operation S400 of generating, by the signal control circuit 100C, the image data DS based on the image signal RGB and the white color coordinates CT.

The signal control circuit 100C1 may include a brightness ratio calculation unit 110C1, a white calculation unit 120C1, a color coordinate calculation unit 130C1, and an image data generation unit 140C1.

The brightness ratio calculation unit 110C1 may receive the image signal RGB and the illuminance value IL. The brightness ratio calculation unit 110C1 may calculate the brightness ratio LR based on the first luminance of external light and the second luminance of the image signal RGB (S100).

The first luminance may be calculated based on the illuminance value IL measured by the illuminance sensor LSN. The brightness ratio calculation unit 110C1 may calculate the first luminance by Equation 3.

$$Ambient luminance = \frac{Illuminance}{\text{?}} \times \frac{1}{5} \qquad [ Equation 3 ]$$

$$\text{?} \text{indicates text missing or illegible when filed}$$

In Equation 3, ambient luminance may denote the first luminance, and illuminance may denote the illuminance value IL. In an embodiment, the illuminance value IL may be obtained by measuring the brightness of a light-receiving surface and may have the unit of lx, for example. The first luminance may be obtained by measuring the brightness emitted by a light-emitting surface and may have the unit of cd/m². Equation 3 may be substantially the same as Equation 0.

The image signal RGB may include a grayscale value. The second luminance may be calculated based on the grayscale value. However, this is an illustrative embodiment. A method for calculating the second luminance in the disclosure is not limited thereto. In an embodiment, the second luminance may be set in advance to a user's preferred brightness, for example.

When the ratio value SR obtained by dividing the first luminance by the second luminance is less than 1, the brightness ratio LR may have the ratio value SR. When the ratio value SR is greater than or equal to 1, the brightness ratio LR may have 1.

In an embodiment of the disclosure, in the signal control circuit 100C1 that generates the image data DS based on the brightness ratio LR, when the luminance of the display layer 100 is brighter than the luminance of external lighting, the illuminance sensor LSN may continuously sense the illuminance value IL and may output the white color coordinates CT. When the luminance of the external lighting is brighter than or equal to the luminance of the display layer 100, the color coordinate calculation unit 130C1 may not calculate white color coordinates CT but may fix the white color coordinates CT to white color coordinates at a point in time, at which the ratio value SR is 1, so as to be output. When the ratio value SR is greater than 1 in the first graph GP1 (refer to FIG. 8A) and the second graph GP2 (refer to FIG. 8B), the CCT neutral point may converge to a predetermined level. Accordingly, even when the white color coordinates CT is fixed to the white color coordinates CT at a point in time when the ratio value SR is 1 and is output, the user may not perceive a difference. Accordingly, the electronic device 1000 with reduced power consumption may be provided.

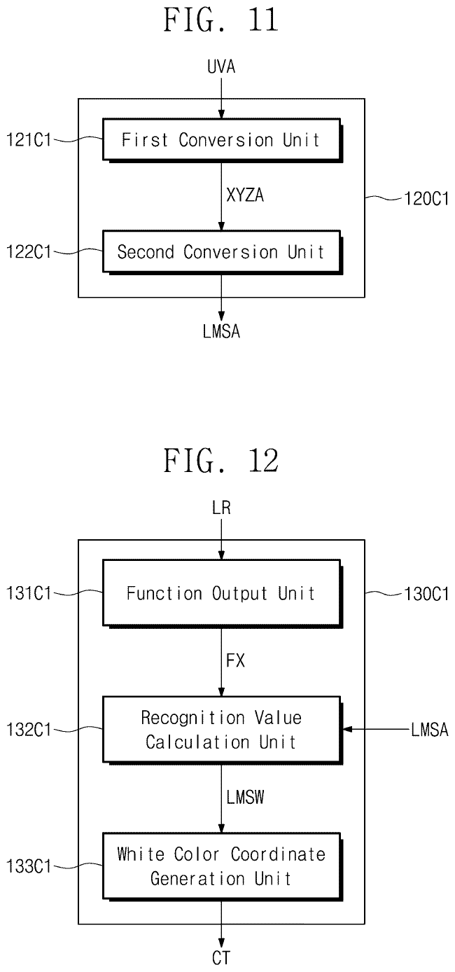

FIG. 11 is a block diagram of an embodiment of a white calculation unit, according to the disclosure.

Referring to FIGS. 10 and 11, the white calculation unit 120C1 may convert the chromaticity of the image signal RGB to the color coordinates LMSA (S200).

The image signal RGB may include u′v′ color coordinates UVA defined in CIE 1976 u′v′ color space. The u′v′ color coordinates UVA may include u′ and v′. u′ and v′ may be defined as coordinates used in CIE 1976 uniform chromaticity scale (“UCS”) diagram in color space.

u′ may be a coordinate indicating a ratio between red and blue components of color at a neutral point. v′ may be a coordinate indicating a ratio between green and blue components at the neutral point.

The white calculation unit 120C1 may include a first conversion unit 121C1 and a second conversion unit 122C1.

The first conversion unit 121C1 may receive the u′v′ color coordinates UVA and may output XYZ tristimulus values XYZA.

The XYZ tristimulus values XYZA are used in the CIE 1931 color space, and are values that consider the color perceived by a human visual system. The XYZ tristimulus values XYZA may include X, Y, and Z.

The first conversion unit 121C1 may convert the u′v′ color coordinates UVA to the XYZ tristimulus values XYZA by Equation 4.

$$Y = \text{?} , X = Y \text{?} , Z = Y \text{?} \qquad [ Equation 4 ]$$

$$\text{?} \text{indicates text missing or illegible when filed}$$

In Equation 4, Y̅ may denote a value indicating luminance. Y̅_̅{̅D̅}̅ may be the luminance of the image IM (refer to FIG. 1), which is to be displayed in the display layer 100 and which is calculated based on a grayscale value of the image signal RGB. That is, Y̅ and Y̅_̅{̅D̅}̅ may be second luminance. X̅ may be a value indicating a color dimension between blue and yellow. Z̅ may be a value indicating a color dimension between red and green.

The second conversion unit 122C1 may receive the XYZ tristimulus values XYZA and may output the long, medium, and short (“LMS”) cone values LMSA.

LMS used in the LMS cone values LMSA may refer to a color sensitivity function used to model a color detection mechanism used to express the sense of color. The LMS may be used to model how the human visual system detects and processes light of different wavelengths. In other words, the LMS may be used to model the response of the human visual system or to understand the operation of a color detection device. The LMS cone values LMSA may include L, M, and S.

The second conversion unit 122C1 may convert the XYZ tristimulus values XYZA to the LMS cone values LMSA by Equation 5.

$$[ \begin{matrix}L \\ M \\ S\end{matrix} ] = \text{?} [ \begin{matrix}X \\ Y \\ Z\end{matrix} ] = [ \begin{matrix}0.401288 & 0.650173 & - 0.051461 \\ - 0.250268 & 1.204414 & 0.045854 \\ - 0.002079 & 0.048952 & 0.953127\end{matrix} ] [ \begin{matrix}X \\ Y \\ Z\end{matrix} ] \qquad [ Equation 5 ]$$

$$\text{?} \text{indicates text missing or illegible when filed}$$

In Equation 5, may denote a long wavelength, may be a component sensitive to the long wavelength, and may be a value for mainly perceiving the brightness or luminance of color. M̅ may denote a medium wavelength, may be a component sensitive to the medium wavelength, and may be a value for mainly perceiving the green part of color. S̅ may denote a short wavelength, may be a component sensitive to the short wavelength, and may be a value for mainly perceiving the blue and purple parts of color. M̅_̅{̅C̅A̅T̅1̅6̅}̅ may be a conversion matrix for converting the XYZ tristimulus values XYZA to the LMS cone values LMSA based on the color sensitivity function.

The LMS cone values LMSA may be also referred to as the “color coordinates LMSA”.

FIG. 12 is a block diagram of an embodiment of a color coordinate calculation unit, according to the disclosure.

Referring to FIGS. 10 to 12, the color coordinate calculation unit 130C1 may calculate the white color coordinates CT based on the brightness ratio LR and the color coordinates LMSA (S300).

The color coordinate calculation unit 130C1 may include a function output unit 131C1, a recognition value calculation unit 132C1, and a white color coordinate generation unit 133C1.

The function output unit 131C1 may receive the brightness ratio LR from the brightness ratio calculation unit 110C1. The function output unit 131C1 may output a function FX obtained by raising the brightness ratio to the power of 0.3. That is, the function output unit 131C1 may output the function FX by Equation 6.

$$f \text{?} = \text{?} \qquad [ Equation 6 ]$$

$$\text{?} \text{indicates text missing or illegible when filed}$$

In Equation 6, f(S_{R}) may denote the function FX, and S̅_̅{̅R̅}̅ may denote the ratio value SR.

The recognition value calculation unit 132C1 may receive the function FX from the function output unit 131C1 and may receive the LMS cone values LMSA from the white calculation unit 120C1. The recognition value calculation unit 132C1 may output corrected LMS cone values LMSW having the corrected color temperature.

The recognition value calculation unit 132C1 may calculate the corrected LMS cone values LMSW by Equation 7.

$$[ Equation 7 ]$$

$${LMS}_{W} = LM \text{?} \times f \text{?} + LM \text{?} \times ( 1 - f \text{?} ) , LM \text{?} = [ \begin{matrix}97.5 & 101.9 & 120.9\end{matrix} ]$$

$$\text{?} \text{indicates text missing or illegible when filed}$$

In Equation 7, L̅M̅S̅_̅{̅W̅}̅ may denote the corrected LMS cone values LMSW; L̅M̅S̅_̅{̅A̅}̅ may denote the LMS cone values LMSA; and f̅(̅S̅_̅{̅R̅}̅)̅ may denote the function FX.

The white color coordinate generation unit 133C1 may receive the corrected LMS cone values LMSW and may output the corrected XYZ tristimulus values CT.

The white color coordinate generation unit 133C1 may calculate the corrected XYZ tristimulus values CT by Equation 8.

$$[ \begin{matrix}X \\ Y \\ Z\end{matrix} ] = \text{?} [ \begin{matrix}L \\ M \\ S\end{matrix} ] \qquad [ Equation 8 ]$$

$$\text{?} \text{indicates text missing or illegible when filed}$$

Equation 8 may be an equation obtained by modifying Equation 5.

$$\text{?}$$

$$\text{?} \text{indicates text missing or illegible when filed}$$

may be the inverse matrix of M̅_̅{̅C̅A̅T̅1̅6̅}̅.

The white color coordinate generation unit 133C1 may normalize and output the corrected XYZ tristimulus values CT by Equation 9.

$$\text{?} = [ \begin{matrix}{X}_{W} \\ {Y}_{W} \\ {Z}_{W}\end{matrix} ] / \text{?} \times \text{?} \qquad [ Equation 9 ]$$

$$\text{?} \text{indicates text missing or illegible when filed}$$

In Equation 9, the corrected XYZ tristimulus values CT may include X̅_̅{̅W̅}̅, Y̅_̅{̅W̅}̅, and Z̅_̅{̅W̅}̅. Y̅_̅{̅O̅}̅ may be the luminance of the image IM (refer to FIG. 1), which is to be displayed in the display layer 100 and which is calculated based on a grayscale value of the image signal RGB. X̅_̅{̅W̅}̅′̅, Y̅_̅{̅W̅}̅′̅, and Z̅_̅{̅W̅}̅′̅ may be the corrected XYZ tristimulus values CT, which is normalized.

In an embodiment of the disclosure, the chromaticity of the neutral point of the corrected XYZ tristimulus values CT may be normalized based on the luminance of the display layer 100 (refer to FIG. 7). Accordingly, the electronic device 1000 (refer to FIG. 7) with improved display quality may be provided.

The corrected XYZ tristimulus values CT may be also referred to as the white color coordinates CT.

The image data generation unit 140C 1 may receive the image signal RGB and the white color coordinates CT.

The image data generation unit 140C1 may generate the image data DS based on the image signal RGB and the white color coordinates CT.

A neutral point perceived by a user's eyes may vary depending on the color temperature of external light. In an embodiment, the white point of a display may appear white to the user in outdoor ambient lighting conditions, but may appear blue to the user in an indoor environment when the user's eyes are acclimated to the warmer light generated by an indoor light source, for example. Moreover, even when the color temperature of external light is the same, the neutral point of the display layer 100 may vary depending on the luminance of each of the external light and the display layer 100. In an embodiment of the disclosure, the signal control circuit 100C1 may output the brightness ratio LR considering the luminance of external light and the luminance of the display layer 100 and may output the white color coordinates CT having the corrected color temperature based on the brightness ratio LR. The signal control circuit 100C1 may generate the image data DS based on the image signal RGB and the white color coordinates CT. Accordingly, the electronic device 1000 with improved display quality may be provided.

Furthermore, according to the disclosure, when the color temperature of the display layer 100 changes depending on the color temperature of the external light, the signal control circuit 100C1 may output the brightness ratio LR based on the first luminance of the external light and the second luminance of the image signal RGB and may output the white color coordinates CT having the corrected color temperature based on the brightness ratio LR. The signal control circuit 100C1 may generate the image data DS based on the image signal RGB and the white color coordinates CT. Accordingly, the electronic device 1000 with improved display quality may be provided.

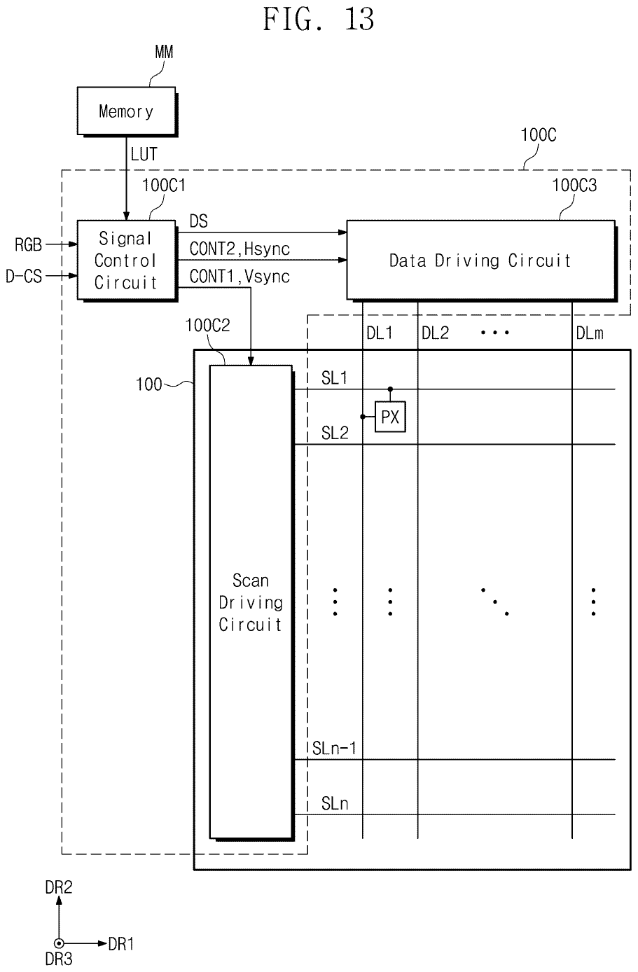

FIG. 13 is a block diagram of an embodiment of a display layer and a display driver, according to the disclosure. In the description of FIG. 13, the same reference numerals are assigned to the same components described with reference to FIG. 7, and thus the descriptions thereof are omitted.

Referring to FIGS. 10 and 13, the electronic device 1000 (refer to FIG. 1) may include a digital signage fixedly installed at a predetermined location externally.

A lookup table LUT may be stored in the memory MM. The signal control circuit 100C1 may receive the lookup table LUT from the memory MM. The lookup table LUT may include a color temperature and brightness according to a predetermined time zone. For this reason, the electronic device 1000 (refer to FIG. 6) may infer and utilize the luminance of external light without the separate illuminance sensor LSN (refer to FIG. 6). In this case, the brightness ratio calculation unit 110C1 may receive the lookup table LUT instead of the illuminance value IL.

In an embodiment of the disclosure, the signal control circuit 100C1 may output the brightness ratio LR considering the lookup table LUT and the luminance of the display layer 100 and may output the white color coordinates CT having the corrected color temperature based on the brightness ratio LR. The signal control circuit 100C1 may generate the image data DS based on the image signal RGB and the white color coordinates CT. Accordingly, the electronic device 1000 with improved display quality may be provided.

Although an embodiment of the disclosure has been described for illustrative purposes, those skilled in the art will appreciate that various modifications, and substitutions are possible, without departing from the scope and spirit of the disclosure as disclosed in the accompanying claims. Accordingly, the technical scope of the disclosure is not limited to the detailed description of this specification, but should be defined by the claims.

As described above, in a signal control circuit that generates image data based on a brightness ratio, when luminance of a display layer is brighter than luminance of external lighting, an illuminance sensor may continuously sense an illuminance value and may output white color coordinates. When the luminance of the external lighting is brighter than or equal to the luminance of the display layer, a color coordinate calculation unit may not calculate white color coordinates but may fix white color coordinates to white color coordinates at a point in time, at which a ratio value is 1, so as to be output. Accordingly, an electronic device with reduced power consumption may be provided.

Moreover, as described above, a signal control circuit may output a brightness ratio that considers the luminance of the external light and the luminance of the display layer, and may calculate the white color coordinates with the corrected color temperature based on the brightness ratio. The signal control circuit may generate image data based on an image signal and the white color coordinates. Accordingly, the electronic device with improved display quality may be provided.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. An electronic device comprising:
a sensor module configured to detect external light;
a display layer configured to display an image; and
a signal control circuit configured to receive an image signal and to generate image data, the signal control circuit including:
a brightness ratio calculation unit configured to calculate a brightness ratio based on first luminance of the external light and second luminance of the image signal;
a white calculation unit configured to convert chromaticity of the image signal into color coordinates; and
a color coordinate calculation unit configured to calculate white color coordinates based on the brightness ratio and the color coordinates,
wherein the signal control circuit generates the image data based on the image signal and the white color coordinates.

2. The electronic device of claim 1, wherein when a ratio value obtained by dividing the first luminance by the second luminance is less than 1, the brightness ratio has the ratio value, and when the ratio value is greater than or equal to 1, the brightness ratio has 1.

3. The electronic device of claim 1, wherein the sensor module includes an illuminance sensor.

4. The electronic device of claim 1, wherein the sensor module measures an external illuminance value,
wherein the brightness ratio calculation unit receives the external illuminance value and calculates the first luminance by Equation 10, and
$$\text{?} \times \text{?} , \qquad [ Equation 10 ]$$
$$\text{?} \text{indicates text missing or illegible when filed}$$
and
wherein in the Equation 10, the ambient luminance denotes the first luminance, and the Illuminance denotes the external illuminance value.

5. The electronic device of claim 1, wherein the color coordinate calculation unit outputs a function obtained by raising the brightness ratio to power of 0.3.

6. The electronic device of claim 5, wherein the image signal includes u′v′ color coordinates.

7. The electronic device of claim 6, wherein the white calculation unit includes:
a first conversion unit configured to convert the u′v′ color coordinates into XYZ tristimulus values; and
a second conversion unit configured to convert the XYZ tristimulus values into long, medium, and short cone values.

8. The electronic device of claim 7, wherein the color coordinate calculation unit calculates corrected long, medium, and short cone values having a corrected color temperature based on the function and the long, medium, and short cone values.

9. The electronic device of claim 8, wherein the color coordinate calculation unit converts the corrected long, medium, and short cone values into corrected XYZ tristimulus values.

10. The electronic device of claim 9, wherein the color coordinate calculation unit normalizes and outputs the corrected XYZ tristimulus values.

11. A method of driving an electronic device, the method comprising:
providing the electronic device including a sensor module configured to detect external light, a display layer, and a signal control circuit configured to receive an image signal and to transmit image data to the display layer;
calculating, by the signal control circuit, a brightness ratio based on first luminance of the external light and second luminance of the image signal;
converting, by the signal control circuit, chromaticity of the image signal into color coordinates;
calculating, by the signal control circuit, white color coordinates based on the brightness ratio and the color coordinates; and
generating, by the signal control circuit, the image data based on the image signal and the white color coordinates.

12. The method of claim 11, wherein the calculating the brightness ratio includes:
when a ratio value obtained by dividing the first luminance by the second luminance is less than 1, defining the brightness ratio as the ratio value.

13. The method of claim 12, wherein the calculating the brightness ratio further includes:
when the ratio value is greater than or equal to 1, defining the brightness ratio as 1.

14. The method of claim 11, wherein the sensor module includes an illuminance sensor.

15. The method of claim 11, wherein the sensor module measures an external illuminance value, and
wherein the calculating the brightness ratio includes:
calculating, by the signal control circuit, the first luminance based on the external illuminance value.

16. The method of claim 11, wherein the calculating the white color coordinates includes:
outputting a function obtained by raising the brightness ratio to power of 0.3.

17. The method of claim 16, wherein the image signal includes u′v′ color coordinates, and
wherein the calculating the white color coordinates further includes:
converting the u′v′ color coordinates into XYZ tristimulus values; and
converting the XYZ tristimulus values into long, medium, and short cone values.

18. The method of claim 17, wherein the calculating the white color coordinates further includes:
calculating corrected long, medium, and short cone values having a corrected color temperature based on the function and the long, medium, and short cone values.

19. The method of claim 18, wherein the calculating the white color coordinates further includes:
converting the corrected long, medium, and short cone values into corrected XYZ tristimulus values.

20. The method of claim 19, wherein the calculating the white color coordinates further includes:
normalizing the corrected XYZ tristimulus values.
